(19) United States
(12) Patent Application Publication
(10) Pub. No.: US 2019/0012092 A1
(43) Pub. Date: Jan. 10, 2019

(54) MANAGING COMPOSABLE COMPUTE SYSTEMS WITH SUPPORT FOR HYPERCONVERGED SOFTWARE DEFINED STORAGE

(71) Applicant: LENOVO ENTERPRISE SOLUTIONS (SINGAPORE) PTE. LTD., SINGAPORE (SG)

(72) Inventors: FRED A. BOWER, III, DURHAM, NC (US); CAIHONG ZHANG, SHANGHAI (CN); DA KE XU, SHANGHAI (CN)

(21) Appl. No.: 15/641,934

(22) Filed: Jul. 5, 2017

(51) Int. Cl. G06F 3/06; H04L 29/08

(52) U.S. Cl. CPC G06F 3/0611; G06F 3/0647; H04L 67/1002; G06F 3/0644; G06F 3/067; G06F 3/0653

(57) ABSTRACT

Managing composable compute systems with support for hyperconverged software defined storage includes: monitoring a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting that a workload on the first composed server of the composable pod targets data on the first data drive of the composable pod; determining that the first data drive of the composable pod is not mapped to the first composed server; and mapping the first data drive containing the data targeted by the workload to the first composed server hosting the workload.

### BACKGROUND

Field of the Invention

The field of the present disclosure is data processing, or, more specifically, methods, apparatus, and products for managing composable compute systems with support for hyperconverged software defined storage.

Description of Related Art

In current cloud computing environments, workload control systems are commonly employed that use software to compose the locally-attached disks of the workload servers into a low-cost pooled storage infrastructure (i.e., storage area networks (“SANs”), network area storage (“NAS”)). These “hyperconverged” systems utilize optimization algorithms to exploit locality of data to workload by migrating the data between server nodes as the workload migrates.

### SUMMARY

Methods, systems, and apparatus for managing composable compute systems with support for hyperconverged software defined storage are disclosed in this specification. Managing composable compute systems with support for hyperconverged software defined storage includes monitoring a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting that a workload on the first composed server of the composable pod targets data on the first data drive of the composable pod; determining that the first data drive of the composable pod is not mapped to the first composed server hosting the workload targeting the data on the first data drive; and mapping the first data drive containing the data targeted by the workload to the first composed server hosting the workload, wherein the workload accesses the data on the first data drive using the mapping between the first composed server and the first data drive.

The foregoing and other objects, features and advantages of the disclosure will be apparent from the following more particular descriptions of exemplary embodiments of the present disclosure as illustrated in the accompanying drawings wherein like reference numbers generally represent like parts of exemplary embodiments of the present disclosure.

### BRIEF DESCRIPTION OF THE DRAWINGS

FIG. 1 sets forth a block diagram of an example system configured for managing composable compute systems with support for hyperconverged software defined storage according to embodiments of the present disclosure.

FIG. 2 sets forth a block diagram for managing composable compute systems with support for hyperconverged software defined storage according to embodiments of the present disclosure.

FIG. 3 sets forth a flow chart illustrating an exemplary method for managing composable compute systems with support for hyperconverged software defined storage according to embodiments of the present disclosure.

FIG. 4 sets forth a flow chart illustrating an exemplary method for managing composable compute systems with support for hyperconverged software defined storage according to embodiments of the present disclosure.

FIG. 5 sets forth a flow chart illustrating an exemplary method for managing composable compute systems with support for hyperconverged software defined storage according to embodiments of the present disclosure.

FIG. 6 sets forth a flow chart illustrating an exemplary method for managing composable compute systems with support for hyperconverged software defined storage according to embodiments of the present disclosure.

FIG. 7 sets forth a flow chart illustrating an exemplary method for managing composable compute systems with support for hyperconverged software defined storage according to embodiments of the present disclosure.

### DETAILED DESCRIPTION

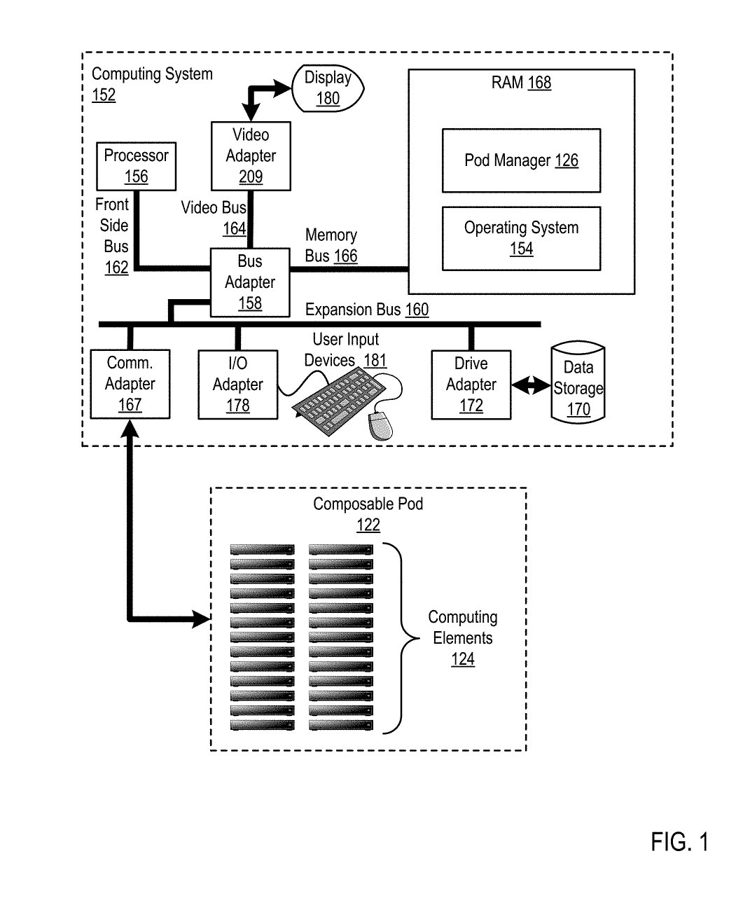

Exemplary methods, apparatus, and products for managing composable compute systems with support for hyperconverged software defined storage in accordance with the present disclosure are described with reference to the accompanying drawings, beginning with FIG. 1. FIG. 1 sets forth a block diagram of automated computing machinery comprising an exemplary computing system (152) configured for managing composable compute systems with support for hyperconverged software defined storage according to embodiments of the present disclosure. The computing system (152) of FIG. 1 includes at least one computer processor (156) or “CPU” as well as random access memory (168) (“RAM”) which is connected through a high speed memory bus (166) and bus adapter (158) to processor (156) and to other components of the computing system (152).

Stored in RAM (168) is an operating system (154). Operating systems useful in computers configured for managing composable compute systems with support for hyperconverged software defined storage according to embodiments of the present disclosure include UNIX™, Linux™, Microsoft Windows™, AIX™, IBM's iOS™, and others as will occur to those of skill in the art. The operating system (154) in the example of FIG. 1 is shown in RAM (168), but many components of such software typically are stored in non-volatile memory also, such as, for example, on a disk drive (170). Also stored in RAM (168) and part of the operating system is a pod manager (126), a module of computer program instructions for managing composable compute systems with support for hyperconverged software defined storage.

The computing system (152) of FIG. 1 includes disk drive adapter (172) coupled through expansion bus (160) and bus adapter (158) to processor (156) and other components of the computing system (152). Disk drive adapter (172) connects non-volatile data storage to the computing system (152) in the form of disk drive (170). Disk drive adapters useful in computers configured for managing composable compute systems with support for hyperconverged software defined storage according to embodiments of the present disclosure include Integrated Drive Electronics (“IDE”) adapters, Small Computer System Interface (“SCSI”) adapters, and others as will occur to those of skill in the art. Non-volatile computer memory also may be implemented for as an optical disk drive, electrically erasable programmable read-only memory (so-called “EEPROM” or “Flash” memory), RAM drives, and so on, as will occur to those of skill in the art.

The example computing system (152) of FIG. 1 includes one or more input/output (“I/O”) adapters (178). I/O adapters implement user-oriented input/output through, for example, software drivers and computer hardware for controlling output to display devices such as computer display screens, as well as user input from user input devices (181) such as keyboards and mice. The example computing system (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing system (152) of FIG. 1 includes a communications adapter (167) for data communications with other computers (182) and for data communications with a data communications network. Such data communications may be carried out serially through RS-232 connections, through external buses such as a Universal Serial Bus (“USB”), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for managing composable compute systems with support for hyperconverged software defined storage according to embodiments of the present disclosure include modems for wired dial-up communications, Ethernet (IEEE 802.3) adapters for wired data communications, and 802.11 adapters for wireless data communications.

The communications adapter (167) of the exemplary computing system (152) of FIG. 1 is connected to a composable pod (122) via a communications bus. The composable pod (122) is a collection of computing elements (124) able to be arranged (i.e., composable) into different configurations based on the data center requirements. Examples of computing elements (124) include compute nodes, memory, communications adapters, I/O adapters, drive adapters, and storage devices such as platter drives and solid state drives. The composable pod (122) may be a set of computing elements configured based on Intel's Rack Scale Design platform.

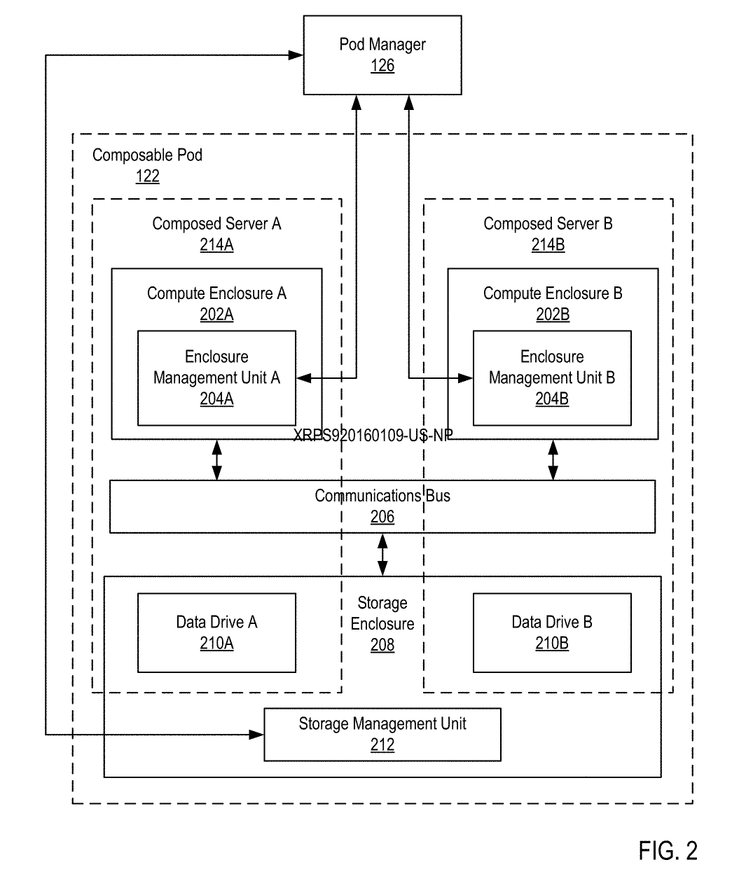

FIG. 2 is an example block diagram of a system configured for managing composable compute systems with support for hyperconverged software defined storage. FIG. 2 includes a pod manager (126) and a composable pod (122). The composable pod (122) includes two compute enclosures (compute enclosure A (202A), compute enclosure B (202)) coupled to a storage enclosure (208) via a communications bus (206). Each compute enclosure (compute enclosure A (202A), compute enclosure B (202B)) includes an enclosure management unit (enclosure management unit A (204A), enclosure management unit B (204B)). The storage enclosure (208) includes two data drives (data drive A (210A), data drive B (210B)) and a storage management unit (212). Compute enclosure A (202A) and data drive A (210A) have been organized into composed server A (214A). Similarly, compute enclosure B (202B) and data drive B (210B) have been organized into composed server B (214B). The pod manager (126) communicates with the compute enclosures (compute enclosure A (202A), compute enclosure B (202)) and the storage enclosure (208) via the management units (enclosure management unit A (204A), enclosure management unit B (204B), storage management unit (212)). Although FIG. 2 shows the composed servers in one particular configuration, other combinations of compute enclosures and data drives are possible. The composed servers (composed server A (214A), composed server B (214B)) host hyperconverged storage software.

The management units ((enclosure management unit A (204A), enclosure management unit B (204B), storage management unit (212))) are controllers responsible for the configuration of the computing elements in the composable pod (122), such as the memory, pooled storage, compute nodes, networking elements, and switch elements. The management units communicate with the pod manager (126) to provide the pod manager (126) with information about the compute enclosures (compute enclosure A (202A), compute enclosure B (202B)) and storage enclosure (208) contained within the composable pod (122). The management units also carries out the instructions received from the pod manager (126), including configuring the composition of the composed servers (composed server A (214A), composed server B (214B)) within the composable pod (122) (e.g., by mapping or unmapping data drives to or from the composed servers).

The communications bus (206) is a device or group of devices that transfers data between computing components in the composable pod (122). The communications bus (206) may be a switching fabric such as a Peripheral Component Interconnect Express (PCIe), Infiniband, Omni-Path, or Ethernet network.

The composed servers (composed server A (214A), composed server B (214B)) are collections of one or more computing elements configured to host one or more workloads. A workload is a process or group of processes that performs a function using data stored on data drives. Workloads may be isolated applications, virtual machines, hypervisors, or another group of processes that work together, using data on a data drive, to perform a function.

The data drives (data drive A (210A), data drive B (210B)) are storage devices used to store data targeted by one or more workloads. Data drives (data drive A (210A), data drive B (210B)) may be included in a composed server or a group of composed servers. Data drives may be physical drives, or virtual drives made up of a portion of a physical drive or a group of physical drives.

The hyperconverged storage software utilizes optimization algorithms to exploit the locality of data to workloads accessing that data. Such optimization algorithms may migrate data between server nodes as workloads are migrated in order to maintain a locality between workload and data. However, such hyperconvergence optimization algorithms may be rendered inefficient within composable systems in which servers are composed of computing elements connected over a communications bus. Specifically, the optimization algorithms may cause unnecessary routing and migration of the data in response to migration across composed servers.

For example, a hyperconverged software controller may determine that a workload on composed server A (214A) which is utilizing data on data drive A (210A) has moved to composed server B (214B). The hyperconverged algorithms will instruct the composed servers to transfer the data in used by the transferred workload to data drive B (210B) because data drive B (210B) is more local to composed server B (214B) now hosting the workload. Doing so requires the source and target composed servers to use resources to copy the data from the source data drive to the target data drive.

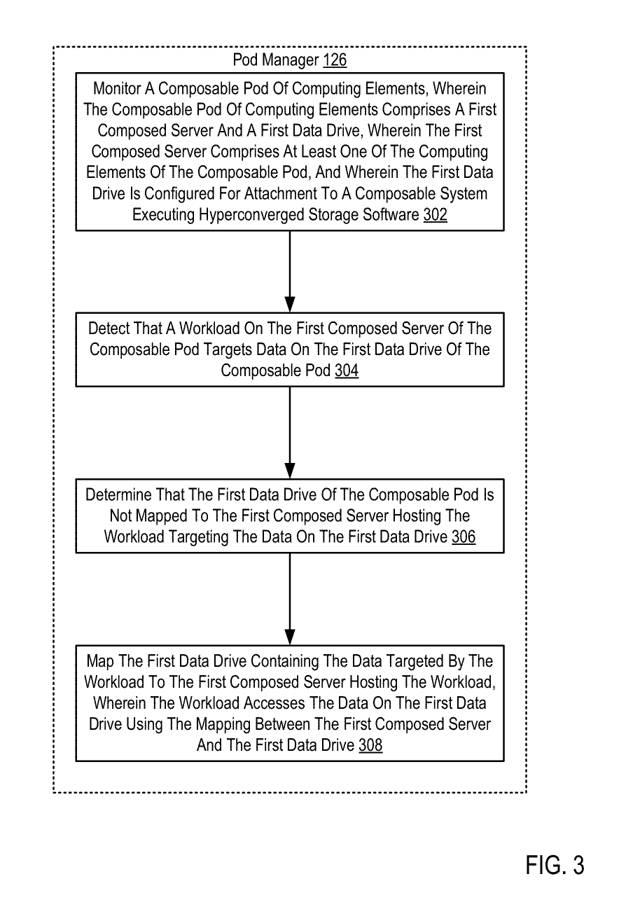

For further explanation, FIG. 3 sets forth a flow chart illustrating an exemplary method for managing composable compute systems with support for hyperconverged software defined storage according to embodiments of the present disclosure. The method of FIG. 3 includes monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software. Monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software may be carried out by connecting data drives within a storage enclosure to compute enclosures via configuration messages sent from the pod manager to the management units of the composed elements. Such messages may be sent from the pod manager to a management unit within the composable elements of the composable pod. Monitoring (302) the composable pod of computing elements may include monitoring workload migrations from one composed server to another composed server, monitoring resource utilization, monitoring wear levels of data drives, and tracking mappings between data drives and composed servers.

For example, a workload may be migrated from a first composed server to a second composed server. A workload manager may notify the pod manager (126) that the workload was migrated from server A to server B. The pod manager (126) may also be informed, or track itself, the data drive mappings for server A and server B. The pod manager (126) may also be informed, or track itself, information about the computing elements that make up server A and server B, as well as the status of the underlying hardware, such as the wear level of the data drives mapped to server A and server B.

The first composed server is made up of computing elements of the composable pod. The computing elements (also referred to as modules) within the composable pod may be configured by the pod manager (126) into servers. For example, a server may be composed of multiple compute nodes, memory, and input/out device compute elements. Each composed server may also be mapped to data drives from a storage pool.

FIG. 3 also includes detecting (304) that a workload on the first composed server of the composable pod targets data on the first data drive of the composable pod. Detecting (304) that a workload on the first composed server of the composable pod targets data on the first data drive of the composable pod may be carried out by receiving or tracking information about the workload. The pod manager (126) may track or be notified of relationships between workloads and data targeted by the workloads. Specifically, the pod manager (126) may maintain information about the mappings between data drives and the composed servers with workloads targeting data on the data drives.

For example, the pod manager (126) may detect that a workload has been migrated to the first composed server, and that the workload was hosted on a composed server that was previously mapped to the first data drive. As another example, the pod manager (126) may detect that a workload on a first composed server targets data on a data drive that should be replaced based on a wear level of the data drive.

FIG. 3 also includes determining (306) that the first data drive of the composable pod is not mapped to the first composed server hosting the workload targeting the data on the first data drive. Determining (306) that the first data drive of the composable pod is not mapped to the first composed server hosting the workload targeting the data on the first data drive may be carried out by tracking or being notified of the data drives accessed by the workload and comparing the list of data drives to the data drives mapped to the first composed server. The comparison may be performed in response to determining that the workload has been migrated from one composed server to another, or in response to determining that the data has been moved from one data drive to another.

FIG. 3 also includes mapping (308) the first data drive containing the data targeted by the workload to the first composed server hosting the workload, wherein the workload accesses the data on the first data drive using the mapping between the first composed server and the first data drive. Mapping (308) the first data drive containing the data targeted by the workload to the first composed server hosting the workload, wherein the workload accesses the data on the first data drive using the mapping between the first composed server and the first data drive may be carried out by generating a logical connection between the first composed server and the first data drive. The logical connection may retain the same reference handle in use by the workload, such as a drive name or drive letter designation. The pod manager (126) may instruct the management unit within the composable pod to map the first data drive to the first composed server. During the mapping procedure, the first composed server or storage enclosure will have to queue traffic until the mapping is complete.

For example, the pod manager may configure a switching fabric to map the first data drive to the first composed server in a PCI domain. Configuring the switching fabric may be performed using the management unit of the composed elements or by reconfiguration of the communications bus interconnect. The workload may have previously accessed the data using a drive designation, and the same drive designation may, once mapping is complete, refer to the first data drive.

Mapping the data drive is distinguishable from mapping the data itself. Specifically, the data stored on the physical or virtual data drive is accessed by the first composed server using the mapping, and the data maintains the same memory address relative to the data drive.

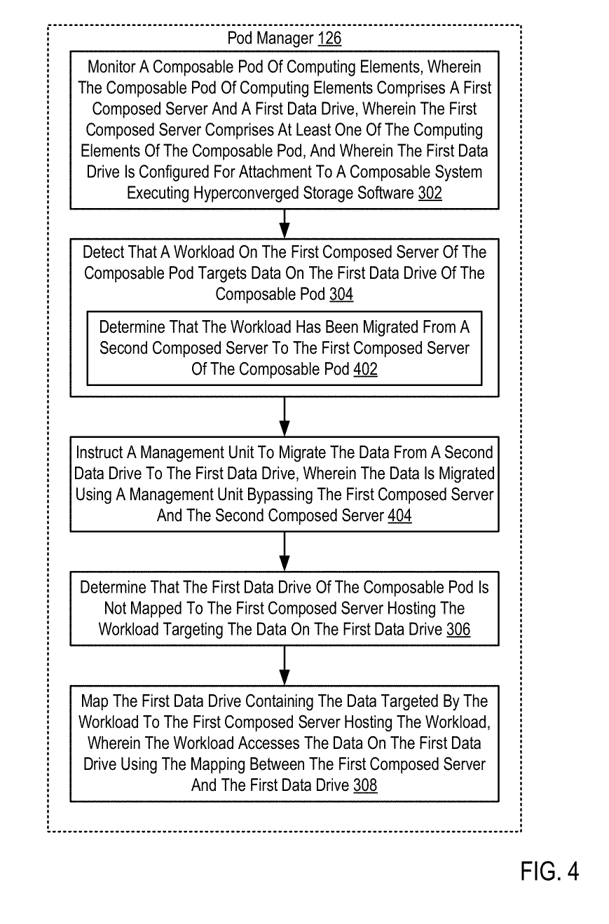

For further explanation, FIG. 4 sets forth a flow chart illustrating an exemplary method for managing composable compute systems with support for hyperconverged software defined storage according to embodiments of the present disclosure that includes monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting (304) that a workload on the first composed server of the composable pod targets data on the first data drive of the composable pod; determining (306) that the first data drive of the composable pod is not mapped to the first composed server hosting the workload targeting the data on the first data drive; and mapping (308) the first data drive containing the data targeted by the workload to the first composed server hosting the workload, wherein the workload accesses the data on the first data drive using the mapping between the first composed server and the first data drive.

The method of FIG. 4 differs from the method of FIG. 3, however, in that detecting (304) that a workload on the first composed server of the composable pod targets data on the first data drive of the composable pod includes determining (402) that the workload has been migrated from a second composed server to the first composed server of the composable pod. Determining (402) that the workload has been migrated from a second composed server to the first composed server of the composable pod may be carried out by tracking or being notified of workload migrations on the composable pod. Determining (402) that the workload has been migrated from a second composed server to the first composed server of the composable pod may also be carried out by the pod manager (126) communicating with hyperconvergence software and determining that the hyperconvergence software has detected that a workload has been migrated to a location that the hyperconvergence software perceives as non-local.

Migrations may be initiated for a number of reasons. For example, an end user with access to multiple composed servers may decide to migrate the workload from one composed server to another. As another example, the migration may be part of load balancing operation performed by the data center administrator or automatically as part of the data center management software. The workload may also be migrated by the hyperconvergence software to maintain a local affinity with another workload. The workload may be migrated by the pod manager (126) or the management unit in order to increase the utilization of the compute elements within the composable pod.

The method of FIG. 4 also differs from the method of FIG. 3, in that FIG. 4 includes instructing (404) a management unit to migrate the data from a second data drive to the first data drive, wherein the data is migrated using a management unit bypassing the first composed server and the second composed server. Instructing (404) a management unit to migrate the data from a second data drive to the first data drive may be carried out by sending a message to the management unit within the composable pod to copy some or all of the data on the second data drive to the first data drive. The message may include a reference to the second data drive and an instruction to migrate the data to an available data drive that meets criteria for mapping to the first composed server.

The first data drive may be mapped to the first composed server at the time of the workload migration. Specifically, the pod manager (126) or the management unit may determine that a data drive currently mapped to the first composed server is adequate to store the data targeted by the workload. The pod manager and/or the management unit may verify the mapping, or notify the workload that that data has completed migration to an existing data drive.

The data may be migrated using a management unit bypassing the first composed server and the second composed server. Specifically, the pod manager may instruct a management unit for the storage enclosure to transfer the targeted data from the second data drive to the first data drive without interaction or utilization of the first composed server or the second composed server. The data may be transferred directly using the resources available to the storage enclosure.

For example, a workload may be migrated from the second composed server to the first composed server. The first data drive may be determined by the pod manger (126) and/or the management unit to be more local to the first composed server than the second data drive. Accordingly, the data targeted by the workload while executing on the second composed server may be copied from the second data drive to the first data drive. The first data drive may then be mapped to the first composed server upon which the workload is currently executing.

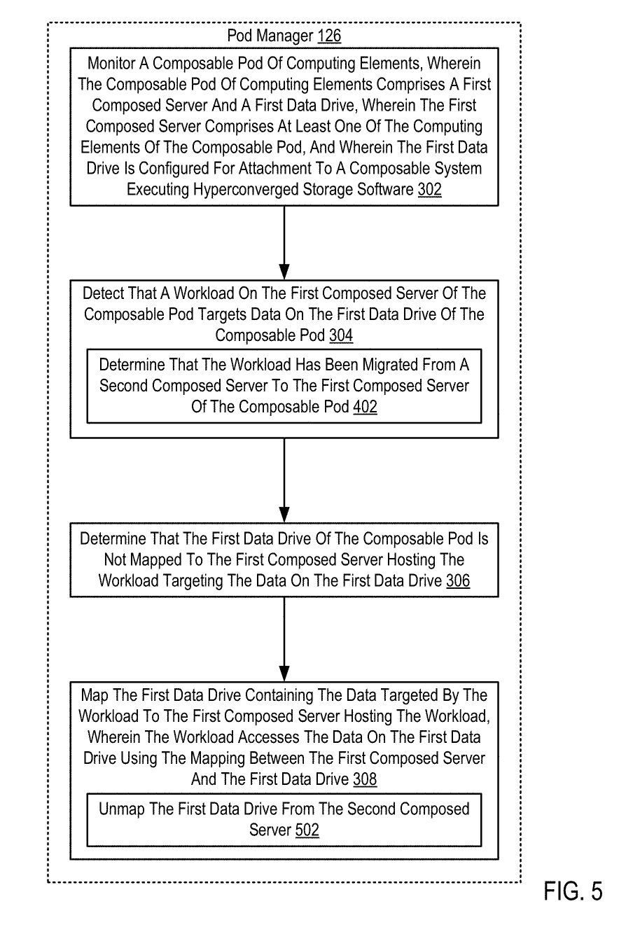

For further explanation, FIG. 5 sets forth a flow chart illustrating an exemplary method for managing composable compute systems with support for hyperconverged software defined storage according to embodiments of the present disclosure that includes monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting (304) that a workload on the first composed server of the composable pod targets data on the first data drive of the composable pod; determining (306) that the first data drive of the composable pod is not mapped to the first composed server hosting the workload targeting the data on the first data drive; and mapping (308) the first data drive containing the data targeted by the workload to the first composed server hosting the workload, wherein the workload accesses the data on the first data drive using the mapping between the first composed server and the first data drive.

The method of FIG. 5 differs from the method of FIG. 3, however, in that detecting (304) that a workload on the first composed server of the composable pod targets data on the first data drive of the composable pod includes determining (402) that the workload has been migrated from a second composed server to the first composed server of the composable pod.

The method of FIG. 5 also differs from the method of FIG. 3, in that mapping (308) the first data drive containing the data targeted by the workload to the first composed server hosting the workload, wherein the workload accesses the data on the first data drive using the mapping between the first composed server and the first data drive includes unmapping (504) the first data drive from the second composed server. Unmapping (502) the first data drive from the second composed server may be carried out by a reconfiguration of the communications bus interconnect and/or the switching elements connected to the communications bus via instructions sent to the management units in control of the switching elements.

For example, a workload may be migrated from the second composed server to the first composed server. Instead of transferring the data to another data drive, the data drive mapped to the second composed server and used to host data used by the workload while executing on the second composed server may be remapped from the second composed server to the first composed server without transferring the data to a new data drive.

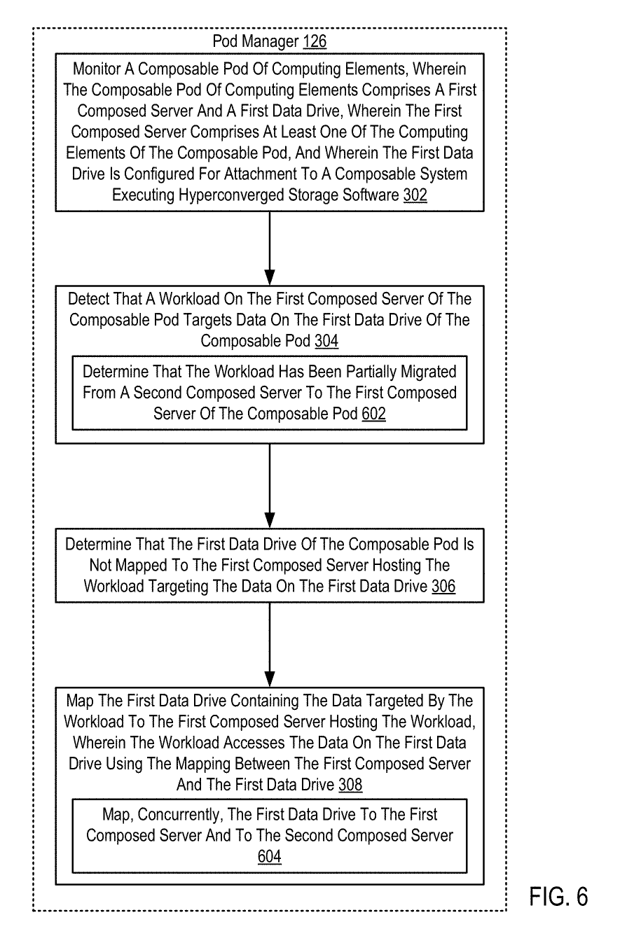

For further explanation, FIG. 6 sets forth a flow chart illustrating an exemplary method for managing composable compute systems with support for hyperconverged software defined storage according to embodiments of the present disclosure that includes monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting (304) that a workload on the first composed server of the composable pod targets data on the first data drive of the composable pod; determining (306) that the first data drive of the composable pod is not mapped to the first composed server hosting the workload targeting the data on the first data drive; and mapping (308) the first data drive containing the data targeted by the workload to the first composed server hosting the workload, wherein the workload accesses the data on the first data drive using the mapping between the first composed server and the first data drive.

The method of FIG. 6 differs from the method of FIG. 3, however, in that detecting (304) that a workload on the first composed server of the composable pod targets data on the first data drive of the composable pod includes determining (602) that the workload has been partially migrated from a second composed server to the first composed server of the composable pod. Determining (602) that the workload has been partially migrated from a second composed server to the first composed server of the composable pod may be carried out by determining that a portion of the workload is to remain on the second composed server. The portion of the workload remaining on the second composed server may, for example, be required to remain on the second composed server in order to service requests without interruption or continue a process that may not be paused without undesired consequences. Determining (602) that the workload has been partially migrated from a second composed server to the first composed server of the composable pod may be carried out by determining that the entire workload has been copied to the first composed server, but is still executing on the second composed server.

The method of FIG. 6 also differs from the method of FIG. 3, in that mapping (308) the first data drive containing the data targeted by the workload to the first composed server hosting the workload, wherein the workload accesses the data on the first data drive using the mapping between the first composed server and the first data drive includes mapping (604), concurrently, the first data drive to the first composed server and to the second composed server. Mapping (604), concurrently, the first data drive to the first composed server and to the second composed server may be carried out by providing a reference to the first data drive to both the first composed server and the second composed server. Both the first composed server and the second composed server may have access to the first data drive using the same or a similar mapping and reference identifier.

For example, a first composed server may be running two virtual machines, each using a portion of a first data drive. One of the two virtual machines may be migrated to a second composed server. In response, the first data drive may be mapped to the second composed server. The first data drive may then be concurrently mapped to both the first composed server and the second composed server.

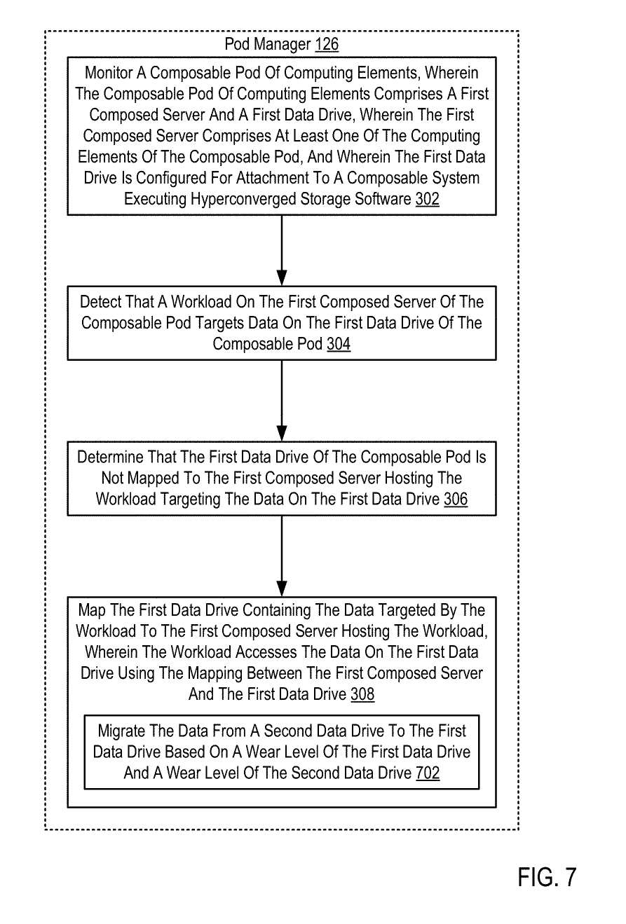

For further explanation, FIG. 7 sets forth a flow chart illustrating an exemplary method for managing composable compute systems with support for hyperconverged software defined storage according to embodiments of the present disclosure that includes monitoring (302) a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software; detecting (304) that a workload on the first composed server of the composable pod targets data on the first data drive of the composable pod; determining (306) that the first data drive of the composable pod is not mapped to the first composed server hosting the workload targeting the data on the first data drive; and mapping (308) the first data drive containing the data targeted by the workload to the first composed server hosting the workload, wherein the workload accesses the data on the first data drive using the mapping between the first composed server and the first data drive.

The method of FIG. 7 differs from the method of FIG. 3, however, in that mapping (308) the first data drive containing the data targeted by the workload to the first composed server hosting the workload, wherein the workload accesses the data on the first data drive using the mapping between the first composed server and the first data drive includes migrating (702) the data from a second data drive to the first data drive based on a wear level of the first data drive and a wear level of the second data drive. Migrating (702) the data from a second data drive to the first data drive based on a wear level of the first data drive and a wear level of the second data drive may be carried out by obtaining the wear level for the first data drive and the wear level for the second data drive.

The wear level of the data drives is an indication of the point in the lifecycle of data drive. The wear level may indicate the proximity of an expected failure of the data drive. The pod manager and/or the management unit of the storage enclosure may compare the wear level of each data drive to one or more wear thresholds. This comparison may result in a determination that the data drive is in a state of over-wear (i.e., close to reaching a maximum wear level) or a state of under-wear (i.e., far from reaching a maximum wear level). Based on the wear level of each data drive and the amount of time the data drives have been in service, data drives may be replaced or swapped. The data may be transferred from one data drive to another directly using the storage enclosure management unit, bypassing the composed server.

For example, the pod manager (126) may determine that the wear level on the second data drive is high, and that the second data drive is in a state of over-wear. The pod manger (126) may then determine that the first data drive is in a state of under-wear, and migrate the data targeted by the workload on the first composed server to the first data drive. The pod manger (126) may then map the first data drive to the first composed server and unmap the second data drive from the first composed server.

As another example, the pod manager (126) may determine that the wear level on the second data drive is low, and that the second data drive is in a state of under-wear. The pod manger (126) may then determine that the second data drive has been in service of a workload on the first composed server for a period of time that indicates the workload causes a very slow progression of the wear level. In order to attempt to coordinate the expected failure time of all disks, the pod manager may swap the second data drive in the state of under-wear with another data drive that is in a state of over-wear.

In view of the explanations set forth above, readers will recognize that the benefits of managing composable compute systems with support for hyperconverged software defined storage according to embodiments of the present disclosure include:
Improving the operation of a computer system by avoiding resource usage in migrating data across drives in storage enclosures, increasing system efficiency.
Improving the operation of a computer system by migrating workload data and mapping the data drives hosting the migrated data to a composed server without utilizing the composed server resources, increasing system efficiency.
Improving the operation of a computer system by mapping a data drive to a composed server hosting a migrated workload, avoiding migrating the data to a new data drive, increasing system efficiency.
Improving the operation of a computer system by mapping data drives to composed servers based on a wear level appropriate for the workload hosted on the composed servers, increasing data drive reliability and operational predictability.

Exemplary embodiments of the present disclosure are described largely in the context of a fully functional computer system for managing composable compute systems with support for hyperconverged software defined storage. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method comprising:
monitoring a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software;
detecting that a workload on the first composed server of the composable pod targets data on the first data drive of the composable pod;
determining that the first data drive of the composable pod is not mapped to the first composed server hosting the workload targeting the data on the first data drive; and
mapping the first data drive containing the data targeted by the workload to the first composed server hosting the workload, wherein the workload accesses the data on the first data drive using the mapping between the first composed server and the first data drive.

2. The method of claim 1, wherein:
detecting that the workload on the first composed server of the composable pod targets data on the first data drive of the composable pod comprises determining that the workload has been migrated from a second composed server to the first composed server of the composable pod; and
prior to determining that the first data drive of the composable pod is not mapped to the first composed server hosting the workload targeting the data on the first data drive, instructing a management unit to migrate the data from a second data drive to the first data drive.

3. The method of claim 2, wherein the data is migrated using a management unit bypassing the first composed server and the second composed server.

4. The method of claim 1, wherein:
detecting that the workload on the first composed server of the composable pod targets data on the first data drive of the composable pod comprises determining that the workload has been migrated from a second composed server to the first composed server of the composable pod; and
mapping the first data drive containing the data targeted by the workload to the first composed server hosting the workload comprises unmapping the first data drive from the second composed server.

5. The method of claim 1, wherein:
detecting that the workload on the first composed server of the composable pod targets data on the first data drive of the composable pod comprises determining that the workload has been partially migrated from a second composed server to the first composed server of the composable pod; and
mapping the first data drive containing the data targeted by the workload to the first composed server hosting the workload comprises mapping, concurrently, the first data drive to the first composed server and to the second composed server.

6. The method of claim 1, wherein mapping the first data drive containing the data targeted by the workload to the first composed server hosting the workload comprises migrating the data from a second data drive to the first data drive based on a wear level of the first data drive and a wear level of the second data drive.

7. The method of claim 1, wherein mapping the first data drive containing the data targeted by the workload to the first composed server hosting the workload comprises instructing a management unit within the composable pod to map the first data drive to the first composed server.

8. An apparatus comprising a computing device, a computer processor, and a computer memory operatively coupled to the computer processor, the computer memory including computer program instructions configured to:
monitor a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software;
detect that a workload on the first composed server of the composable pod targets data on the first data drive of the composable pod;
determine that the first data drive of the composable pod is not mapped to the first composed server hosting the workload targeting the data on the first data drive; and
map the first data drive containing the data targeted by the workload to the first composed server hosting the workload, wherein the workload accesses the data on the first data drive using the mapping between the first composed server and the first data drive.

9. The apparatus of claim 8, wherein:
detecting that the workload on the first composed server of the composable pod targets data on the first data drive of the composable pod comprises determining that the workload has been migrated from a second composed server to the first composed server of the composable pod; and
prior to determining that the first data drive of the composable pod is not mapped to the first composed server hosting the workload targeting the data on the first data drive, instructing a management unit to migrate the data from a second data drive to the first data drive.

10. The apparatus of claim 9, wherein the data is migrated using a management unit bypassing the first composed server and the second composed server.

11. The apparatus of claim 8, wherein:
detecting that the workload on the first composed server of the composable pod targets data on the first data drive of the composable pod comprises determining that the workload has been migrated from a second composed server to the first composed server of the composable pod; and
mapping the first data drive containing the data targeted by the workload to the first composed server hosting the workload comprises unmapping the first data drive from the second composed server.

12. The apparatus of claim 8, wherein:
detecting that the workload on the first composed server of the composable pod targets data on the first data drive of the composable pod comprises determining that the workload has been partially migrated from a second composed server to the first composed server of the composable pod; and
mapping the first data drive containing the data targeted by the workload to the first composed server hosting the workload comprises mapping, concurrently, the first data drive to the first composed server and to the second composed server.

13. The apparatus of claim 8, wherein mapping the first data drive containing the data targeted by the workload to the first composed server hosting the workload comprises migrating the data from a second data drive to the first data drive based on a wear level of the first data drive and a wear level of the second data drive.

14. The apparatus of claim 8, wherein mapping the first data drive containing the data targeted by the workload to the first composed server hosting the workload comprises instructing a management unit within the composable pod to map the first data drive to the first composed server.

15. A computer program product including a computer readable medium, the computer program product comprising computer program instructions configured to:
monitor a composable pod of computing elements, wherein the composable pod of computing elements comprises a first composed server and a first data drive, wherein the first composed server comprises at least one of the computing elements of the composable pod, and wherein the first data drive is configured for attachment to a composable system executing hyperconverged storage software;
detect that a workload on the first composed server of the composable pod targets data on the first data drive of the composable pod;
determine that the first data drive of the composable pod is not mapped to the first composed server hosting the workload targeting the data on the first data drive; and
map the first data drive containing the data targeted by the workload to the first composed server hosting the workload, wherein the workload accesses the data on the first data drive using the mapping between the first composed server and the first data drive.

16. The computer program product of claim 15, wherein:
detecting that the workload on the first composed server of the composable pod targets data on the first data drive of the composable pod comprises determining that the workload has been migrated from a second composed server to the first composed server of the composable pod; and
prior to determining that the first data drive of the composable pod is not mapped to the first composed server hosting the workload targeting the data on the first data drive, instructing a management unit to migrate the data from a second data drive to the first data drive.

17. The computer program product of claim 16, wherein the data is migrated using a management unit bypassing the first composed server and the second composed server.

18. The computer program product of claim 15, wherein:
detecting that the workload on the first composed server of the composable pod targets data on the first data drive of the composable pod comprises determining that the workload has been migrated from a second composed server to the first composed server of the composable pod; and
mapping the first data drive containing the data targeted by the workload to the first composed server hosting the workload comprises unmapping the first data drive from the second composed server.

19. The computer program product of claim 15, wherein:
detecting that the workload on the first composed server of the composable pod targets data on the first data drive of the composable pod comprises determining that the workload has been partially migrated from a second composed server to the first composed server of the composable pod; and
mapping the first data drive containing the data targeted by the workload to the first composed server hosting the workload comprises mapping, concurrently, the first data drive to the first composed server and to the second composed server.

20. The computer program product of claim 15, wherein mapping the first data drive containing the data targeted by the workload to the first composed server hosting the workload comprises migrating the data from a second data drive to the first data drive based on a wear level of the first data drive and a wear level of the second data drive.
